(19) United States
(12) Patent Application Publication
(10) Pub. No.: US 2026/0358165 A1
(43) Pub. Date: Nov. 12, 2026

(54) METHODS FOR EFFICIENT DETECTION OF LIQUID LEVEL DEPTH IN LONG-DISTANCE PIPE STRING BASED ON SHORT-TIME LINEAR FREQUENCY MODULATED EXCITATION

(71) Applicant: CHONGQING UNIVERSITY OF POSTS AND TELECOMMUNICATIONS, Chongqing (CN)

(72) Inventors: Jiufei LUO, Chongqing (CN); Hongyu LI, Chongqing (CN); Sheng LU, Chongqing (CN); Yi ZENG, Chongqing (CN); Yuxin LI, Chongqing (CN); Yao WANG, Chongqing (CN); Ping'an YANG, Chongqing (CN); Shuai HUANG, Chongqing (CN)

(73) Assignee: CHONGQING UNIVERSITY OF POSTS AND TELECOMMUNICATIONS, Chongqing (CN)

(21) Appl. No.: 19/678,805

(22) Filed: May 15, 2026

Related U.S. Application Data
(63) Continuation of application No. PCT/CN2026/081978, filed on Mar. 6, 2026.

(30) Foreign Application Priority Data
May 6, 2025 (CN) 202510573344.X

(51) Int. Cl. G01F 23/296

(52) U.S. Cl. CPC G01F 23/296

(57) ABSTRACT

A method for efficient detection of a liquid level depth in a long-distance pipe string based on short-time linear frequency modulated excitation is provided. The method includes: inputting a linear frequency modulated acoustic wave into a long-distance pipe string to continuously resonate an air column inside the pipe string; collecting an acoustic signal of the air column inside the pipe string; calculating a frequency magnitude at a non-integer index within an excitation frequency band using a DFT to obtain a refined spectrum; normalizing the refined spectrum and taking a logarithm of the refined spectrum to obtain a logarithmic spectrum; performing smoothing and filtering on the logarithmic spectrum to obtain resonance characteristics; performing a FFT on the resonance characteristics, and estimating a count of resonance peaks of the resonance characteristics; and calculating the liquid level depth of the long-distance pipe string based on the count of resonance peaks.

### CROSS-REFERENCE TO RELATED APPLICATIONS

This application is a continuation of International Application No. PCT/CN2026/081978, filed on Mar. 6, 2026, which claims priority to Chinese Patent Application No. 202510573344.X, filed on May 6, 2025, the entire contents of each of which are incorporated herein by reference.

### TECHNICAL FIELD

The present disclosure relates to a field of liquid level depth detection in a long-distance pipe string, and in particular, to a method for efficient detection of a liquid level depth in a long-distance pipe string based on short-time linear frequency modulated excitation.

### BACKGROUND

In fields of petroleum engineering, chemical engineering, aerospace, or the like, a liquid level is an important control parameter. Real-time, fast, and accurate liquid level detection is a key link for determining a system working state and performing monitoring and maintenance, and has become a necessary task for ensuring safe production. In practical applications of industrial scenarios such as oil well dynamic liquid level measurement, cross-regional long pipeline transportation, and large-scale water conservancy projects, a length of a pipe string usually exceeds 500 m and even reaches several thousand meters. A demand for liquid level detection over a long distance is increasingly prominent.

At the present stage, a liquid level measurement manner based on a pipe string sound field model transmits white noise and a high-frequency linear acoustic wave to excite an air column inside the pipe string, collects a resonance signal, and then performs signal processing to achieve measurement of a liquid level depth according to a mathematical relationship between a resonance characteristic and a length of the pipe string. However, in a long-distance propagation process, a high-frequency component of the acoustic wave attenuates rapidly, and often completely attenuates before propagating to a liquid surface, which seriously affects an excitation effect. Secondly, an acoustic signal collected by an acoustic sensor includes not only an air column resonance signal but also interferences such as an excitation source itself and complex background noise. A weak resonance signal is easily submerged, which seriously interferes with extraction and recognition of the resonance characteristic, thereby affecting stability and accuracy of the liquid level measurement, and even causing a relatively large measurement error.

Therefore, a method for efficient detection of a liquid level depth in a long-distance pipe string based on short-time linear frequency modulated excitation is provided, which improves anti-noise capability while preventing a measurement result from being affected by an arrangement manner of the long-distance pipe string and shortening a measurement time.

### SUMMARY

To solve problems existing in the prior art, the present disclosure provides a method for efficient detection of a liquid level depth in a long-distance pipe string based on short-time linear frequency modulated excitation, the method comprising:
S101: arranging a measuring device at a port of the long-distance pipe string;
S102: setting parameters of a measuring device, and the measuring device inputs a generated linear frequency modulated acoustic wave into the long-distance pipe string to continuously resonate an air column inside the pipe string;
S103: collecting an acoustic signal of the air column inside the pipe string, filtering the acoustic signal, and normalizing a filtered acoustic signal to obtain a normalized time-domain signal;
S104: performing windowing on the normalized time-domain signal using a Planck-taper window function;
S105: calculating, based on a windowed time-domain signal, a frequency magnitude at a non-integer index within an excitation frequency band using a discrete Fourier transform (DFT), and adding additional refined frequency points between every two adjacent spectral lines to obtain a refined spectrum with a denser distribution; normalizing the obtained refined spectrum, and taking a logarithm of a magnitude spectrum obtained after the normalization to obtain a logarithmic spectrum;
S106: performing smoothing and filtering on the logarithmic spectrum to obtain a filtering result;
S107: correspondingly subtracting the filtering result from the logarithmic spectrum to obtain resonance characteristics of the windowed time-domain signal;
S108: performing a fast Fourier transform (FFT) on resonance characteristics to obtain H(r); calculating a correction quantity using a three-spectral-line interpolation manner based on the obtained H(r), and estimating a count of resonance peaks of the resonance characteristics based on the correction quantity; and calculating the liquid level depth of the long-distance pipe string based on the count of resonance peaks.

The method provided in some embodiments of the present disclosure includes, but is not limited to, beneficial effects as follows.

The method adopts short-time linear frequency modulated acoustic wave excitation, which can effectively solve problems of rapid attenuation of excitation acoustic wave energy and difficulty in extracting weak resonance characteristics caused by noise excitation. The method is not limited by an arrangement mode of the long-distance pipe string, has good anti-noise performance, can realize rapid extraction of the resonance characteristics, extends a measurement range, provides reliable technical support for liquid level detection of the long-distance pipe string under complex noise backgrounds, and realizes accurate detection of the liquid level depth of the long-distance pipe string in a plurality of application scenarios. In some embodiments of the present disclosure, the Planck-taper window function is used to perform windowing on the normalized time-domain signal, and the correction quantity of the windowed time-domain signal is estimated through the three-spectral-line interpolation manner, thereby improving accuracy of liquid level detection of the long-distance pipe string.

### BRIEF DESCRIPTION OF THE DRAWINGS

FIG. 1 is an exemplary flowchart of a method for efficient detection of a liquid level depth in a long-distance pipe string based on short-time linear frequency modulated excitation according to some embodiments of the present disclosure;

FIG. 2 is a time-domain diagram of an acoustic signal collected by an acoustic sensor according to some embodiments of the present disclosure;

FIG. 3 is a signal diagram illustrating a collected acoustic signal after being filtered by a time-varying band-pass filter according to some embodiments of the present disclosure;

FIG. 4 is a signal diagram obtained after a filtered acoustic signal is normalized according to some embodiments of the present disclosure;

FIG. 5 is a time-domain signal diagram of a normalized time-domain signal after being windowed with a Planck-taper window function according to some embodiments of the present disclosure;

FIG. 6 is a refined spectrum diagram obtained by calculating an excitation frequency band using a DFT according to some embodiments of the present disclosure;

FIG. 7 is a comparison diagram of a logarithmic spectrum and a filtering result after smoothing and filtering the logarithmic spectrum after normalization of a refined spectrum according to some embodiments of the present disclosure;

FIG. 8 is a schematic diagram illustrating resonance characteristics obtained by correspondingly subtracting a filtering result from a logarithmic spectrum according to some embodiments of the present disclosure;

FIG. 9 is a schematic diagram illustrating a calculation result of a count of resonance peaks obtained by estimating parameters through a three-spectral-line interpolation manner after an FFT is performed on resonance characteristics according to some embodiments of the present disclosure.

### DETAILED DESCRIPTION

The technical solutions in the embodiments of the present disclosure are clearly and completely described below with reference to the accompanying drawings of the embodiments of the present disclosure. It is apparent that the described embodiments are merely a portion of the embodiments of the present disclosure, and not all of the embodiments. Based on the embodiments in the present disclosure, all other embodiments obtained by those skilled in the art without making inventive efforts fall within the protection scope of the present disclosure.

A method for efficient detection of a liquid level depth in a long-distance pipe string based on short-time linear frequency modulated excitation, comprising:
S101: arranging a measuring device at a port of the long-distance pipe string;
S102: setting parameters of the measuring device, and the measuring device inputs a generated linear frequency modulated acoustic wave into the long-distance pipe string to continuously resonate an air column inside the pipe string;
S103: collecting an acoustic signal of the air column inside the pipe string, filtering the acoustic signal, and normalizing a filtered acoustic signal to obtain a normalized time-domain signal;
S104: performing windowing on the normalized time-domain signal using a Planck-taper window function;
S105: calculating, based on a windowed time-domain signal, a frequency magnitude at a non-integer index within an excitation frequency band using a DFT, and adding additional refined frequency points between every two adjacent spectral lines to obtain a refined spectrum with a denser distribution; normalizing the obtained refined spectrum, and taking a logarithm of a magnitude spectrum obtained after the normalization to obtain a logarithmic spectrum;
S106: performing smoothing and filtering on the logarithmic spectrum to obtain a filtering result;
S107: correspondingly subtracting the filtering result from the logarithmic spectrum to obtain resonance characteristics of the windowed time-domain signal;
S108: performing a FFT on the resonance characteristics to obtain H(r); calculating a correction quantity using a three-spectral-line interpolation manner based on the obtained H(r), and estimating a count of resonance peaks of the resonance characteristics based on the correction quantity; and calculating the liquid level depth of the long-distance pipe string based on the count of resonance peaks.

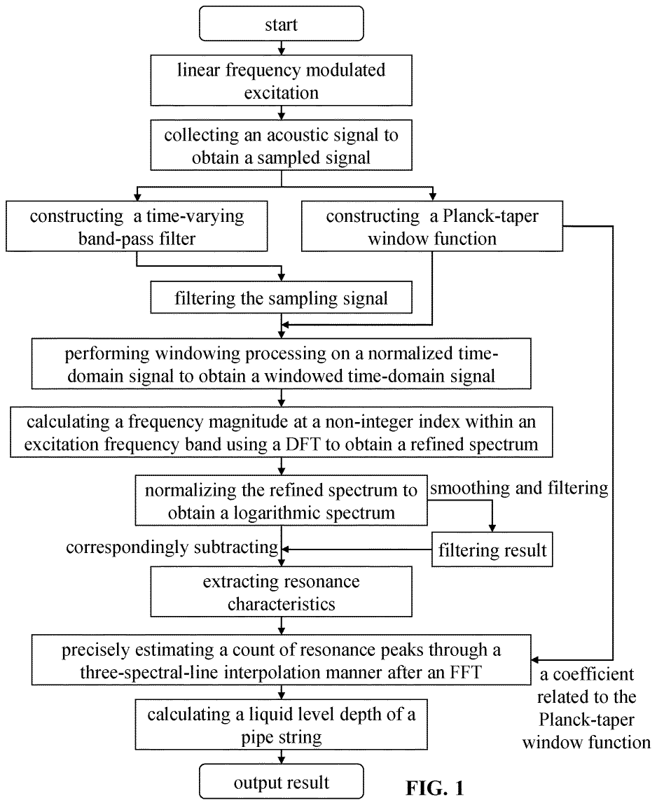

FIG. 1 is an exemplary flowchart of a method for efficient detection of a liquid level depth in a long-distance pipe string based on short-time linear frequency modulated excitation according to some embodiments of the present disclosure.

According to some embodiments of the present disclosure, a method for efficient detection of a liquid level depth in a long-distance pipe string based on short-time linear frequency modulated excitation is provided. The term ‘short-time’ does not specifically refer to a fixed duration, but rather refers to a short-duration transient excitation manner relative to traditional long-duration continuous excitation, indicating that it is capable of effectively exciting resonance of the air column inside the pipe string and capable of completing signal acquisition within a short time. As shown in FIG. 1, the method includes following steps. In some embodiments, steps S2-S9 of the method may be executed by the measuring device. In some embodiments, the measuring device includes a processor. For example, the processor may be a central processing unit (CPU), a graphics processing unit (GPU), an application-specific integrated circuit (ASIC), or other hardware device capable of computing. The processor may further include a cache, registers, and other computing resources to improve processing efficiency. The processor may work cooperatively with other hardware components (e.g., memory, input/output interfaces, or the like) to complete the reading, processing, and output of data. The method may be executed by the processor of the measuring device.

In S1, the measuring device may be installed.

The measuring device is configured to detect a liquid level of a target pipe string. The measuring device may be an ultrasonic liquid level detection device, an acoustic detection device, or the like. The target pipe string refers to a pipe string facility that needs liquid level detection. For example, the target pipe string may be an oil well, a pipeline, or the like.

In some embodiments, the target pipe string is a long-distance pipe string. For example, the target pipe string may be an oil well or a pipeline with a length greater than a preset length threshold (e.g., 500 meters).

In some embodiments, the measuring device may be arranged at the port of the long-distance pipe string.

In some embodiments, the measuring device includes a signal generator, an excitation acoustic source, and an acoustic sensor. The signal generator, the excitation acoustic source, and the acoustic sensor are all installed on a same side of the port of the long-distance pipe string (e.g., an open end). The excitation acoustic source is installed at the open end of the long-distance pipe string, and the acoustic sensor is adjacent to the excitation acoustic source (i.e., the acoustic sensor is installed near the excitation acoustic source).

The signal generator is configured to generate a linear frequency modulated signal, the excitation acoustic source is configured to generate a linear frequency modulated acoustic wave, and the acoustic sensor is configured to collect the acoustic signal. The linear frequency modulated signal may be a preset control signal configured to control the excitation acoustic source to generate the linear frequency modulated acoustic wave. The acoustic signal collected by the acoustic sensor includes an acoustic signal under a pipe string internal environment, including, but not limited to, the linear frequency modulated acoustic wave, ambient noise, or the like.

It should be noted that the measuring device may further include other components. For example, the measuring device also includes a digital-to-analog conversion device, a power amplifier, a filter, or the like.

In some embodiments of the present disclosure, by installing the signal generator, the excitation acoustic source, and the acoustic sensor on the same side of the long-distance pipe string, and adjacently arranging the acoustic sensor to the excitation acoustic source, the synchronicity of the excitation acoustic source emission and the acoustic sensor collection can be improved, and time delay errors can be reduced.

In S2, excitation may be carried out by means of linear frequency modulation.

In some embodiments, parameters of the measuring device may be preset. The parameters of the measuring device refer to working parameters of one or a plurality of components in the measuring device (e.g., the signal generator, the acoustic sensor, or the like), which may be preset by a technician according to demands and experience.

In some embodiments, the parameters of the measuring device include a sampling frequency fₛ and a total sampling time T of the acoustic sensor, and a start frequency f_{L} and an end frequency f_{U} of the linear frequency modulated signal of the signal generator. The measuring device may, based on the parameters of the signal generator, generate the linear frequency modulated signal using the signal generator and transmit the linear frequency modulated signal to the excitation acoustic source, thereby continuously driving the excitation acoustic source to generate the linear frequency modulated acoustic wave.

In some embodiments, the signal generator generates the linear frequency modulated signal, converts the linear frequency modulated signal into an analog signal by means of digital-to-analog conversion, inputs the analog signal into the power amplifier, inputs an amplified analog signal into the excitation acoustic source, and continuously drives the excitation acoustic source to generate the linear frequency modulated acoustic wave.

In some embodiments of the present disclosure, the analog signal is amplified by the power amplifier to a level sufficient to drive the excitation acoustic source, thereby ensuring that the linear frequency modulated acoustic wave has sufficient energy to propagate to the liquid level in the pipe string (especially the long-distance pipe string) and return. Meanwhile, continuously driving the excitation acoustic source also allows the air column to establish stable and continuous resonance.

In S3, the acoustic signal may be collected to obtain a sampled signal.

In some embodiments, the parameters of the measuring device are set. The measuring device inputs the generated linear frequency modulated acoustic wave into the long-distance pipe string to continuously resonate the air column inside the pipe string.

The air column inside the pipe string refers to a spatial region inside the pipe string that is filled with air from the open end to the liquid level. For example, for the long-distance pipe string (e.g., an oil well, a pipeline, or the like), the air column inside the pipe string is a columnar space inside the pipe string, from the open end to the liquid level.

The sampling signal refers to an acoustic signal inside the pipe string collected under preset sampling parameters. The preset sampling parameters include a sampling frequency, a sampling period, a sampling duration, or the like.

In some embodiments, the measuring device may utilize the acoustic sensor to collect the acoustic signal of the air column inside the pipe string based on the sampling frequency fₛ and the total sampling time T, thereby obtaining the sampling signal. In some embodiments, the acoustic sensor collects an acoustic signal y₀(n) under a linear frequency modulated excitation. The acoustic signal y₀(n) includes a linear frequency modulated acoustic wave signal generated by the excitation acoustic source and a higher-order response of the linear frequency modulated acoustic wave signal, a resonance signal of the air column inside the pipe string, a noise, and interference.

In S4, a time-varying band-pass filter may be constructed to filter the sampling signal.

In some embodiments, the measuring device may collect the acoustic signal of the air column inside the pipe string, filter the acoustic signal, and normalize the filtered acoustic signal to obtain the normalized time-domain signal.

Filtering the acoustic signal may be achieved by performing filtering on the acoustic signal (i.e., the sampling signal) using a filter. The filter may be configured to perform filtering on the acoustic signal (i.e., the sampling signal) to eliminate interference.

In some embodiments, the filter is the time-varying band-pass filter. The time-varying band-pass filter refers to a band-pass filter whose center frequency varies with time. The time-varying band-pass filter may be configured to suppress the higher-order response of the linear frequency modulated acoustic wave signal and a noise of a measuring system and an environment.

In some embodiments, the filter is the time-varying band-pass filter with a center frequency f_{c} varying with an instantaneous frequency of a tracked linear frequency modulated acoustic wave, and a bandwidth F_{b}. The measuring device may be configured to perform filtering on the acoustic signal y₀(n) through the time-varying band-pass filter, thereby obtaining a filtered time-domain signal y₁(n).

In some embodiments of the present disclosure, through the time-varying band-pass filter, a response signal component within a selected frequency range can be effectively extracted, and simultaneously, effective suppression of the higher-order response u(n) of the linear frequency modulated acoustic wave and noise z(n) of a measuring system and an environment can be achieved.

In some embodiments, the measuring device performs normalization processing on the filtered time-domain signal y₁(n), thereby obtaining the normalized time-domain signal yₙₒᵣₘ(n) and causing a signal magnitude to be normalized to a range of [−1,1].

The normalization processing performed on the filtered time-domain signal may be referred to as time-domain normalization processing. The time-domain normalization processing may be configured to process a magnitude of the filtered time-domain signal to obtain the magnitude in the range of [−1,1]. The time-domain normalization processing may be implemented based on a maximum value normalization algorithm, that is, each sampling point is divided by a maximum absolute value of the filtered time-domain signal.

In S5, a Planck-taper window function may be constructed, and windowing processing may be performed on the normalized time-domain signal to obtain a windowed time-domain signal.

The Planck-taper window function refers to a window function configured to smoothly zero out two ends of a time-domain signal. The measuring device may utilize the Planck-taper window function to perform windowing processing on the normalized time-domain signal.

In some embodiments, the measuring device may perform windowing processing on the normalized time-domain signal yₙₒᵣₘ(n) obtained in step S4 using a Planck-taper window function wₚ(n), thereby obtaining a weighted processed signal, which may be expressed based on a following expression:

y(n)=yₙₒᵣₘ(n)·wₚ(n).

In some embodiments of the present disclosure, by performing windowing processing on the normalized time-domain signal, a Gibbs phenomenon of the spectrum subsequently obtained via DFT can be effectively reduced, and spectrum magnitude distortion caused by an endpoint discontinuity of the normalized time-domain signal can be decreased.

In S6, the frequency magnitude at the non-integer index within the excitation frequency band may be calculated using the DFT, the refined spectrum may be obtained, frequency domain normalization may be performed on the obtained refined spectrum, and the logarithm of the magnitude spectrum obtained after the normalization may be taken to obtain the logarithmic spectrum.

The refined spectrum refers to a spectrum obtained by adding additional refined frequency points between adjacent spectral lines of the spectrum, which has a higher frequency resolution and denser spectral lines.

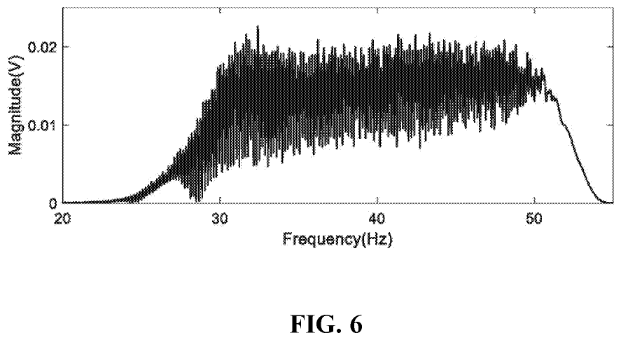

Frequency domain normalization processing may be configured to process a magnitude of the refined spectrum to obtain a normalized magnitude spectrum in a range of [0, 1]. Frequency domain normalization may be implemented based on the maximum value normalization algorithm, that is, a magnitude of each frequency point is divided by a maximum magnitude of the spectrum. More descriptions regarding frequency domain normalization processing may be found elsewhere in the present disclosure (e.g., FIG. 6).

In some embodiments, the measuring device may, based on the windowed time-domain signal, calculate the frequency magnitude at the non-integer index within the excitation frequency band using DFT, and add additional refined frequency points between every two adjacent spectral lines to obtain the refined spectrum Yₗ(k) with a denser distribution; normalize the obtained refined spectrum (i.e., perform frequency domain normalization processing), thereby obtaining Y̅(k); and take the logarithm of the magnitude spectrum obtained after the normalization to obtain the logarithmic spectrum Y(k).

The adjacent spectral lines refer to spectral lines (i.e., frequency points) at two adjacent indexes (e.g., k and k+1).

In some embodiments, the measuring device may calculate the frequency magnitude at the non-integer index within the excitation frequency band in the windowed time-domain signal y(n) using DFT, and add the additional refined frequency points between the every two adjacent spectral lines. For example, the measuring device may insert a non-integer index between any two adjacent integer indexes. The non-integer index may be half of an interval between the two adjacent indexes. Merely by way of example, 1.5 is inserted between integer indexes 1 and 2, 2.5 is inserted between integer indexes 2 and 3, and so on, thereby obtaining a plurality of non-integer indexes. The measuring device adds an additional refined frequency point at each non-integer index, thereby obtaining a refined spectrum with a denser distribution.

In some embodiments of the present disclosure, obtaining the refined spectrum with the denser distribution can significantly reduce a computational amount of frequency domain analysis while making the spectrum smoother.

In S7, smoothing and filtering may be performed, and the resonance characteristics may be extracted.

In some embodiments, the measuring device performs smoothing and filtering on the logarithmic spectrum Y(k), thereby obtaining a filtering result Ω(k).

The smoothing and filtering processing may be implemented based on algorithms including, but not limited to, a Gaussian smoothing algorithm, a median filtering algorithm, or the like.

Subsequently, the measuring device correspondingly subtracts the filtering result Ω(k) from the logarithmic spectrum Y(k), thereby extracting the resonance characteristics G(k) of the windowed time-domain signal.

The resonance characteristics are configured to reflect a natural vibration frequency and a distribution pattern of resonance peaks of the air column inside the pipe string.

Correspondingly subtracting the filtering result Ω(k) from the logarithmic spectrum Y(k) refers to performing subtraction processing on corresponding frequency points (i.e., same frequency points) of the logarithmic spectrum Y(k) and the filtering result Ω(k) respectively (i.e., correspondingly subtracting the spectrum), thereby obtaining periodic resonance peaks.

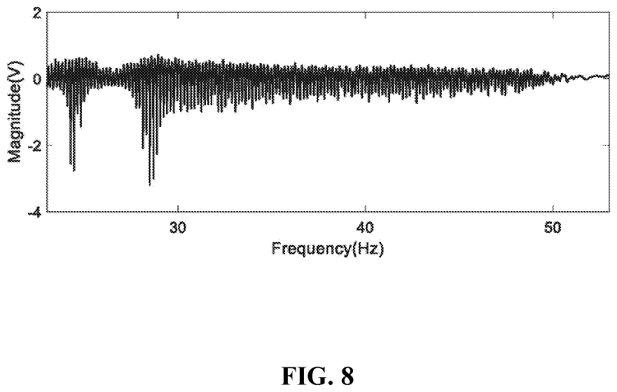

The resonance characteristics G(k) include a series of continuous resonance peaks and have a very strong periodicity. The count of resonance peaks of the acoustic signal may be obtained through a parameter precise estimation algorithm (e.g., the three-spectral-line interpolation manner). More descriptions regarding the count of resonance peaks may be found elsewhere in the present disclosure (e.g., FIG. 8 and related descriptions thereof).

The count of resonance peaks of the acoustic signal refers to the count of resonance peaks of the resonance characteristics G(k), which may be abbreviated as the count of resonance peaks in following descriptions.

The parameter precise estimation algorithm refers to an algorithm for determining the count of resonance peaks, which may be a combination of one or a plurality of preset algorithms. For example, the parameter precise estimation algorithm may include the FFT, the three-spectral-line interpolation manner, or the like.

In S8, after the FFT, the count of resonance peaks may be precisely estimated through the three-spectral-line interpolation manner.

The count of resonance peaks η also refers to a normalized frequency of periodic components in the resonance characteristics G(k).

In some embodiments, the measuring device performs a FFT on the resonance characteristics G(k) to obtain H(r); determines a correction quantity δ using the three-spectral-line interpolation manner based on the obtained H(r); and estimates the count of resonance peaks of the resonance characteristics based on the correction quantity. l denotes a maximum spectral line number in H(r); and δ(−0.5≤δ≤0.5) also denotes a normalized frequency correction quantity.

H(r) represents a spectrum of the resonance characteristics G(k). The normalized frequency correction quantity δ is configured to correct a normalized offset of a spectrum peak position deviation caused by FFT discrete sampling. The normalized frequency correction quantity δ may be simply referred to as the correction quantity δ.

In some embodiments, the measuring device may use a highest spectral line in H(r) and two second highest spectral lines on the left and right sides thereof, determine the correction quantity δ using the three-spectral-line interpolation manner, and finally determine an accurate estimated value of the count of resonance peaks.

The accurate estimated value of the count of resonance peaks is determined based on a sum value of the maximum spectral line number in H(r) and the normalized frequency correction quantity. More descriptions regarding calculating the correction quantity using the three-spectral-line interpolation manner may be found elsewhere in the present disclosure (e.g., FIG. 8 and related descriptions thereof).

In S9, the liquid level depth of the pipe string may be calculated.

The liquid level depth of the pipe string refers to a distance from the open end to the liquid level (liquid surface) inside the pipe string. The measuring device may determine the liquid level depth of the pipe string (e.g., the long-distance pipe string) based on the count of resonance peaks.

In some embodiments, the measuring device may determine the liquid level depth of the pipe string at a long distance (e.g., greater than a preset length threshold (e.g., 500)) based on a mathematical relationship between the accurately estimated count of resonance peaks and the liquid level depth.

The mathematical relationship between the count of resonance peaks and the liquid level depth refers to a mapping relationship or a functional relationship between the count of resonance peaks and the liquid level depth, configured to determine the liquid level depth of the pipe string. The mathematical relationship may be obtained based on historical experience. More descriptions regarding the determination of the liquid level depth of the pipe string may be found in following related descriptions.

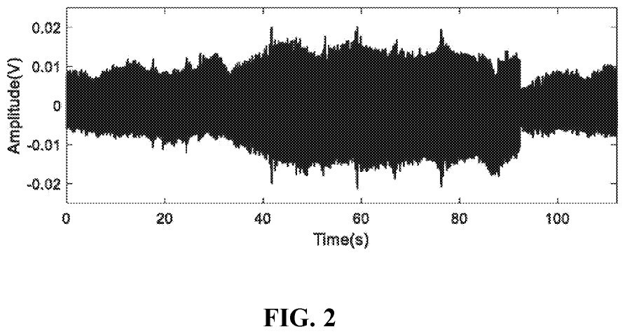

FIG. 2 is a time-domain diagram of an acoustic signal collected by an acoustic sensor according to some embodiments of the present disclosure.

Hereinafter, taking an experimental pipeline as a target pipe string as an example, a description will be made of a method for efficient detection of a liquid level depth in a long-distance pipe string based on short-time linear frequency modulated excitation, provided by some embodiments of the present disclosure. In the present embodiment, the measuring device is installed, the excitation acoustic source is installed at an open end of the experimental pipeline, the acoustic sensor is installed at a front end of the excitation acoustic source, an inner diameter of the experimental pipeline d_{c} is 0.46 m, and an actual distance from the open end to the liquid surface is 956.29 m.

A sampling frequency is set to 5120 Hz; a start frequency of linear frequency modulated excitation is 12 Hz; an end frequency is 67 Hz; a frequency change rate is 0.5 Hz/s; a total sampling time is 110 s; and a sound speed inside the pipe string is approximately 348.8 m/s.

The time-domain signal of the acoustic signal collected by the acoustic sensor under linear frequency modulated excitation is shown in FIG. 2, where it is evident that a useful signal is completely submerged. After constructing a time-varying band-pass filter to perform filtering processing on the collected acoustic signal y₀(n), a filtered time-domain signal y₁(n) is obtained. A center frequency f_{c} of the time-varying band-pass filter varies in a range of 12 Hz to 67 Hz, and a bandwidth F_{b} is 8 Hz.

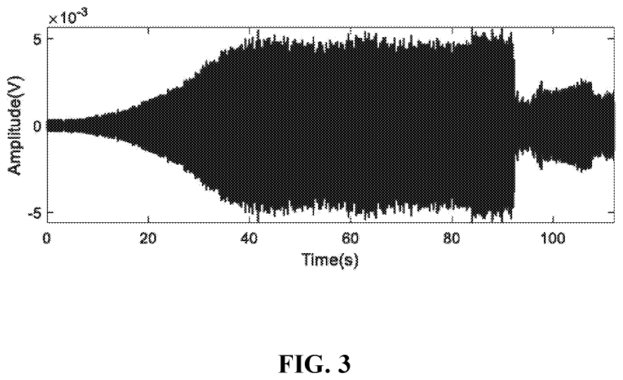

FIG. 3 is a signal diagram illustrating a collected acoustic signal after being filtered by a time-varying band-pass filter according to some embodiments of the present disclosure.

The filtered time-domain signal y₁(n) is shown in FIG. 3, where it is evident that acoustic signal components within a selected frequency range have been effectively extracted, while a high-order response u(n) to a linear frequency modulated acoustic wave and noise of a measuring system and an environment z(n) have been effectively suppressed. Normalization processing is performed on the filtered time-domain signal y₁(n) to obtain yₙₒᵣₘ(n), and a calculation equation is expressed as:

$${y}_{norm} ( n ) = \frac{{y}_{1} ( n )}{max ( {y}_{1} ( n ) )} .$$

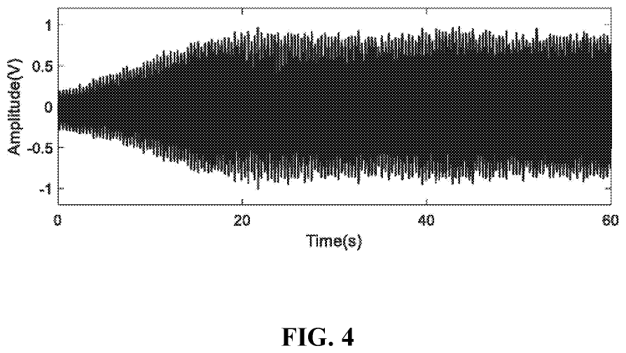

FIG. 4 is a signal diagram obtained after a filtered acoustic signal is normalized according to some embodiments of the present disclosure.

After normalization processing, the acoustic signal with a time range of 20 s to 80 s is shown in FIG. 4, and a corresponding excitation frequency band range is 22 Hz to 52 Hz. It is evident that a magnitude of the acoustic signal has been normalized to a range of [−1, 1]. A Planck-taper window function ωₚ(n) is constructed to perform weighting processing on the time-domain signal.

In some embodiments, the Planck-taper window function ωₚ(n) is expressed based on a following equation:

$${w}_{p} ( n ) \{ \begin{matrix}0 , n = 0 \\ \frac{1}{1 + exp ( ℰ ( N - 1 ) ( \frac{1}{n} + \frac{1}{n - ℰ ( N - 1 )} ) )} , 0 < n < ℰ ( N - 1 ) \\ 1 , ℰ ( N - 1 ) \leq n \leq ( 1 - ℰ ) ( N - 1 ) \\ \frac{1}{1 + exp ( ℰ ( N - 1 ) ( \frac{1}{N - 1 - n} + \frac{1}{( 1 - ℰ ) ( N - 1 ) - n} ) )} , ( 1 - ℰ ) ( N - 1 ) < n < N - 1 \\ 0 , n = N - 1\end{matrix} ,$$

where, ε denotes a transition bandwidth control parameter of the Planck-taper window function, N denotes a count of points in the window function, and n denotes a sample index.

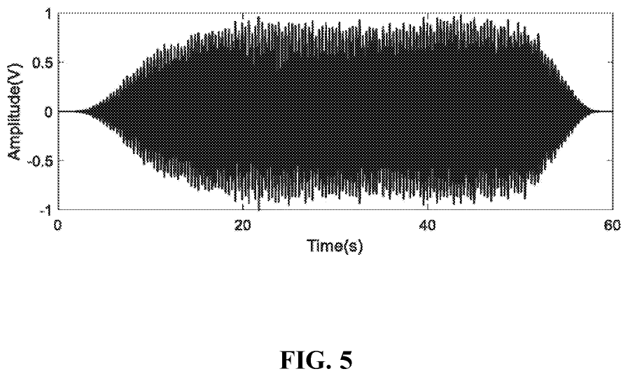

FIG. 5 is a time-domain signal diagram of a normalized time-domain signal after being windowed with a Planck-taper window function according to some embodiments of the present disclosure.

A parameter of the Planck-taper window function is set as a transition bandwidth control parameter ε=0.2. The windowed time-domain signal y(n) is shown in FIG. 5, and it is evident that two ends of the windowed time-domain signal exhibit edge smooth attenuation, which effectively suppresses the Gibbs phenomenon in the spectrum, suppresses energy overshoot at truncation boundaries, and also retains the main signal components well.

Considering that an excitation frequency band range in the windowed time-domain signal y(n) is 20 Hz to 55 Hz, a frequency magnitude at a non-integer index within the excitation frequency band range is determined using a DFT, additional refined frequency points are added between every two adjacent spectral lines, thereby obtaining a refined spectrum Yₗ(k) with a denser distribution.

In some embodiments, a calculation equation for obtaining the refined spectrum with the denser distribution is expressed as:

$${Y}_{l} ( k ) = {\sum }_{n = 0}^{N - 1} y ( n ) {e}^{- j \frac{2 π}{N} kn} ,$$

$$k ∈ \{ {k}_{1} , {k}_{1} + \frac{1}{2} , {k}_{1} + 1 , … , {k}_{2} - \frac{1}{2} , {k}_{2} \} ,$$

$$y ( n ) = {y}_{norm} ( n ) \cdot {w}_{p} ( n ) ,$$

$${y}_{norm} ( n ) = \frac{{y}_{0} ( n )}{max ( {y}_{0} ( n ) )} ,$$

where, k₁ and k₂ respectively denote upper and lower limit frequencies of an excitation frequency band; k denotes a frequency index; N denotes a count of points in the window function; n denotes a sample index; yₙₒᵣₘ(n) denotes a normalized time-domain signal; wₚ(n) denotes a Planck-taper window function; y₀(n) denotes a acoustic signal; and y(n) denotes a weighted processed time-domain signal.

FIG. 6 is a refined spectrum diagram obtained by calculating an excitation frequency band using a DFT according to some embodiments of the present disclosure.

The obtained refined spectrum is shown in FIG. 6. It is evident that the considered excitation frequency band already includes effective resonance characteristics of the pipe string.

After normalization processing is performed on the refined spectrum, Y̅(k) is obtained, and a calculation equation is expressed as:

$$\overline{Y} ( k ) = \frac{{Y}_{l} ( k )}{max ( {Y}_{l} ( k ) )} ,$$

where, Yₗ(k) denotes the refined spectrum; and max (Yₗ(k)) denotes a maximum magnitude of the refined spectrum Yₗ(k).

A logarithm is taken of a normalized result Y̅(k) to obtain a logarithmic spectrum Y(k), and a calculation equation is expressed as:

Y(k)=log(Y̅(k)).

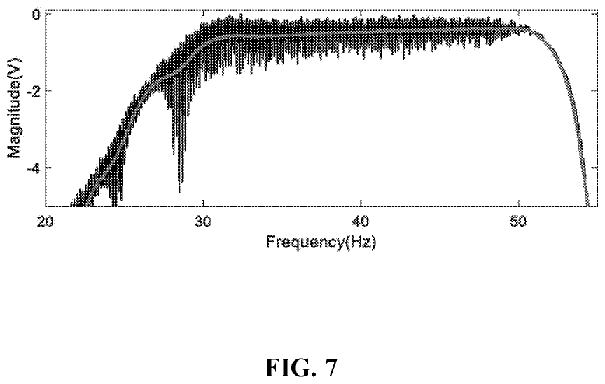

FIG. 7 is a comparison diagram of a logarithmic spectrum and a filtering result after smoothing and filtering the logarithmic spectrum after normalization of a refined spectrum according to some embodiments of the present disclosure.

Smoothing and filtering are performed on the logarithmic spectrum Y(k), as shown in FIG. 7. A thick line portion in FIG. 7 is a filtering result Ω(k) of frequency band smoothing and filtering, which is unknown interference imposed on resonance characteristics caused by characteristics of a measuring system. The filtering result is correspondingly subtracted from the logarithmic spectrum to achieve extraction of resonance characteristics G(k), and a calculation equation is expressed as:

G(k)=Y(k)−Ω(k),k₁<k<k₂,

where, k₁ and k₂ respectively denote an upper limit frequency and a lower limit frequency of the selected frequency band, and according to the considered excitation frequency band, k₁=20 Hz and k₂=55 Hz.

FIG. 8 is a schematic diagram illustrating resonance characteristics obtained by correspondingly subtracting a filtering result from a logarithmic spectrum according to some embodiments of the present disclosure.

The extracted resonance characteristics G(k) are shown in FIG. 8. It is evident that the extracted resonance characteristics have exhibited strong periodicity. A FFT is performed on the resonance characteristics G(k) to obtain H(r), and it is determined that a spectral line number l corresponding to a maximum spectral line in H(r) is 165.

In some embodiments, estimating a count of resonance peaks of the resonance characteristics based on a correction quantity may be implemented based on a following equation:

η=l+δ,

where, η denotes the count of resonance peaks; l denotes a maximum spectral line number in H(r); and δ denotes a normalized frequency correction quantity.

By means of the three-spectral-line interpolation manner, an accurate parameter estimation is performed on δ, and a calculation equation is expressed as:

$$δ = E \cdot \frac{\vert H ( l + 1 ) \vert - \vert H ( l - 1 ) \vert}{\vert H ( l ) \vert + \vert H ( l + 1 ) \vert + \vert H ( l - 1 ) \vert} ,$$

where, |H(l)|, |H(l−1)|, and |H(l+1)| denote magnitudes corresponding to a highest spectral line and two second highest spectral lines on a left and right side thereof in H(r); E denotes a coefficient related to a Planck-taper window function. E may be a preset value. For example, E may be a fixed value determined based on a type of the Planck-taper window function.

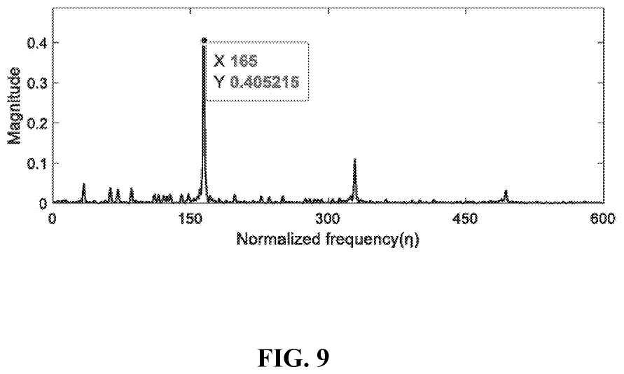

FIG. 9 is a schematic diagram illustrating a calculation result of a count of resonance peaks obtained by estimating parameters through a three-spectral-line interpolation manner after an FFT is performed on resonance characteristics according to some embodiments of the present disclosure.

Since a transition bandwidth control parameter δ of a Planck-taper window function is 0.2, E is determined to be 1.08, and thus a correction quantity δ is determined to be −0.4815 by substituting E into a three-spectral-line interpolation manner. Finally, it may be obtained that a calculation result of the count of resonance peaks is shown in FIG. 9, and a normalized frequency η=164.5021.

Based on a relationship between the count of resonance peaks and the liquid level depth of the pipe string, the liquid level depth of the long-distance pipe string L may be determined, and a calculation equation is expressed as:

$$L = \frac{c}{2} \frac{η {N}_{0}}{{Mf}_{s}} - 0.3 {d}_{c} ,$$

where, c denotes a mean sound speed inside the long-distance pipe string; η denotes the count of resonance peaks; N₀ denotes a total count of points of the acoustic signal y₀(n); M denotes a count of points included in the resonance characteristics G(k); fₛ denotes a sampling frequency; and d_{c} denotes an inner diameter of the long-distance pipe string. By substituting the parameters into the above equation, the length L of the experimental pipeline may be determined to be 956.1839 m, and an actual measurement error is merely 10.6 cm.

The embodiments described above further illustrate the objectives, technical solutions, and advantages of the present disclosure. It should be understood that the embodiments described above are merely preferred embodiments of the present disclosure, and are not intended to limit the present disclosure. Any modifications, equivalent substitutions, improvements, or the like made to the present disclosure within the spirit and principle of the present disclosure shall be included in the scope of protection of the present disclosure.

What is claimed is:

1. A method for efficient detection of a liquid level depth in a long-distance pipe string based on short-time linear frequency modulated excitation, comprising:
S101: arranging a measuring device at a port of the long-distance pipe string;
S102: setting parameters of the measuring device, wherein the measuring device inputs a generated linear frequency modulated acoustic wave into the long-distance pipe string to continuously resonate an air column inside the pipe string;
S103: collecting an acoustic signal of the air column inside the pipe string, filtering the acoustic signal, and normalizing a filtered acoustic signal to obtain a normalized time-domain signal;
S104: performing windowing on the normalized time-domain signal using a Planck-taper window function;
S105: calculating, based on a windowed time-domain signal, a frequency magnitude at a non-integer index within an excitation frequency band using a discrete Fourier transform (DFT), and adding additional refined frequency points between every two adjacent spectral lines to obtain a refined spectrum with a denser distribution; normalizing the obtained refined spectrum, and taking a logarithm of a magnitude spectrum obtained after the normalization to obtain a logarithmic spectrum;
S106: performing smoothing and filtering on the logarithmic spectrum to obtain a filtering result;
S107: correspondingly subtracting the filtering result from the logarithmic spectrum to obtain resonance characteristics of the windowed time-domain signal;
S108: performing a fast Fourier transform (FFT) on the resonance characteristics to obtain H(r); calculating a correction quantity using a three-spectral-line interpolation manner based on the obtained, and estimating a count of resonance peaks of the resonance characteristics based on the correction quantity; and calculating the liquid level depth of the long-distance pipe string based on the count of resonance peaks H(r).

2. The method according to claim 1, wherein the measuring device includes a signal generator, an excitation acoustic source, and an acoustic sensor; wherein,
the signal generator, the excitation acoustic source, and the acoustic sensor are installed on a same side of the port of the long-distance pipe string;
the signal generator is configured to generate a linear frequency modulated signal;
the excitation acoustic source is installed at an open end of the long-distance pipe string, the acoustic sensor is adjacent to the excitation acoustic source, the excitation acoustic source is configured to generate a linear frequency modulated acoustic wave, and the acoustic sensor is configured to collect the acoustic signal.

3. The method according to claim 1, wherein the generating a linear frequency modulated acoustic wave by the measuring device includes:
generating, by a signal generator, a linear frequency modulated signal, and converting the linear frequency modulated signal into an analog signal by means of digital-to-analog conversion;
inputting the analog signal into a power amplifier, inputting an amplified analog signal into an excitation acoustic source, and continuously driving the excitation acoustic source to generate the linear frequency modulated acoustic wave.

4. The method according to claim 1, wherein a filter is a time-varying band-pass filter with a center frequency f_{c} varying with an instantaneous frequency of a tracked linear frequency modulated acoustic wave, and a bandwidth F_{b}.

5. The method according to claim 1, wherein the Planck-taper window function wₚ(n) is expressed as:
$${w}_{p} ( n ) \{ \begin{matrix}0 , n = 0 \\ \frac{1}{1 + exp ( ℰ ( N - 1 ) ( \frac{1}{n} + \frac{1}{n - ℰ ( N - 1 )} ) )} , 0 < n < ℰ ( N - 1 ) \\ 1 , ℰ ( N - 1 ) \leq n \leq ( 1 - ℰ ) ( N - 1 ) \\ \frac{1}{1 + exp ( ℰ ( N - 1 ) ( \frac{1}{N - 1 - n} + \frac{1}{( 1 - ℰ ) ( N - 1 ) - n} ) )} , ( 1 - ℰ ) ( N - 1 ) < n < N - 1 \\ 0 , n = N - 1\end{matrix} ,$$
where, ε denotes a transition bandwidth control parameter of the Planck-taper window function, N denotes a count of points in the window function, and n denotes a sample index.

6. The method according to claim 1, wherein the obtaining a refined spectrum with a denser distribution includes:
$${Y}_{l} ( k ) = {\sum }_{n = 0}^{N - 1} y ( n ) {e}^{- j \frac{2 π}{N} kn} ,$$
$$k ∈ \{ {k}_{1} , {k}_{1} + \frac{1}{2} , {k}_{1} + 1 , … , {k}_{2} - \frac{1}{2} , {k}_{2} \} ,$$
$$y ( n ) = {y}_{norm} ( n ) \cdot {w}_{p} ( n ) ,$$
$${y}_{norm} ( n ) = \frac{{y}_{0} ( n )}{max ( {y}_{0} ( n ) )} ,$$
where, k₁ and k₂ respectively denote upper and lower limit frequencies of an excitation frequency band; k denotes a frequency index; N denotes a count of points in the window function, η denotes a sample index, yₙₒᵣₘ(n) denotes the normalized time-domain signal, wₚ(n) denotes the Planck-taper window function, y₀(n) denotes the acoustic signal, and y(n) denotes a weighted processed time-domain signal.

7. The method according to claim 1, wherein the calculating a correction quantity using a three-spectral-line interpolation manner includes:
$$δ = E \cdot \frac{\vert H ( l + 1 ) \vert - \vert H ( l - 1 ) \vert}{\vert H ( l ) \vert + \vert H ( l + 1 ) \vert + \vert H ( l - 1 ) \vert} ,$$
where, |H(l)|, |H(l−1)|, and |H(l+1)| denote magnitudes corresponding to a highest spectral line and two second highest spectral lines on a left and right side thereof in the H(r); E denotes a coefficient related to the Planck-taper window function.

8. The method according to claim 1, wherein the estimating a count of resonance peaks of the resonance characteristics based on the correction quantity includes:
η=l+δ,
where, l denotes a maximum spectral line number in the H(r); δ denotes a normalized frequency correction quantity.

9. The method according to claim 1, wherein the calculating the liquid level depth of the long-distance pipe string based on the count of resonance peaks includes:
$$L = \frac{c}{2} \frac{η {N}_{0}}{{Mf}_{s}} - 0.3 {d}_{c} ,$$
where, c denotes a mean sound speed inside the long-distance pipe string; η denotes the count of resonance peaks; N₀ denotes a total count of points of the acoustic signal y₀(n); M denotes a count of points included in the resonance characteristics G(k); fₛ denotes a sampling frequency; d_{c} denotes an inner diameter of the long-distance pipe string.
